(19) United States
(12) Patent Application Publication
(10) Pub. No.: US 2012/0304135 A1
(43) Pub. Date: Nov. 29, 2012

(54) METHOD AND APPARATUS FOR PRECISION TUNABLE MACRO-MODEL POWER ANALYSIS

(75) Inventor: Benjamin Schafer Carrion, Tokyo (JP)

(73) Assignee: NEC CORPORATION, Tokyo (JP)

(21) Appl. No.: 13/576,101

(22) PCT Filed: Mar. 31, 2010
(86) PCT No.: PCT/JP2010/056281

§ 371 Date: Jul. 30, 2012

(51) Int. Cl. G06F 17/50

(52) U.S. Cl. 716/104; 716/109

(57) ABSTRACT

A method for estimating power consumption of a target device upon designing the target device, includes: preparing a hybrid power library having a regression power library part and lookup-table power library part, the hybrid power library storing power characteristics for each of basic building blocks which will constitute the target device; and estimating power consumption of the target device by applying the hybrid power library to a design description of the target device.

### TECHNICAL FIELD

The present invention relates to electronic design automation (EDA) for semiconductor devices such as ICs (integrated circuits), LSIs (large-scale integrations) and VLSIs (very-large-scale integrations), and more particularly to a method and apparatus for circuit design for the quick and accurate estimation of power consumption in a target semiconductor device.

### BACKGROUND ART

Power or power consumption is becoming one of the most important design parameters in VLSI designs, especially in designs of VLSIs for embedded systems. High power consumption drains the battery life of portable systems faster and affects the reliability of VLSI circuits by raising the circuit temperature. Temperature in turn affects the type of package and heat sink to be used for an IC or VLSI, which directly affects the cost of the IC or VLSI. It is therefore extremely important to understand where and how much power is consumed in each circuit unit or block in an VLSI in order to apply power reduction measures.

A VLSI is typically designed by performing the stages of: (i) describing behavior of the target VLSI; (ii) describing the hardware at register transfer level (RTL); (iii) generating gate netlists; and (iv) laying out the circuits and wirings of the target VLSI, in this order. C or SystemC language is used in the behavioral description stage while VHDL (VHSIC (Very High Speed. Integrated Circuits) Hardware Description Language)) or Verilog language is used in the RTL stage. Attempt for reducing the power consumption of the target VLSI can be carried out at each of these design levels.

FIG. 1 shows an overview of the most important power reduction measures and highlights at which design stages macro-model power estimation are used. It can be observed in FIG. 1 that more effective and larger variety of these measures can be implemented at earlier design stages, e.g., behavioral level stage 101 or RTL stage 102, and that the power estimation at the earlier stages has larger potential for power savings than the later design stages. In addition, the power estimation speed at the earlier stages is faster than that at the later design stages.

Power estimation techniques at these early design stages are based on the pre-characterization of the power consumption of basic building blocks (also called atomic units) constituting the target VLSI, which are stored in power characterization libraries. This approach is called macro-model power estimation. The main problem when estimating power at a higher level of abstraction is that these power estimation methods are less accurate. On the other hand, power estimation methods at lower stages in the design process, e.g., gate netlist stage 103 and layout stage 104, are extremely slow, but very accurate. Inaccuracies of the macro-model power estimation can lead to the implementation of power reduction methods at the wrong design unit or not implementing any power saving technique at some units that consume most of the power. It is therefore highly desirable to have fast power estimation methods at the earliest possible design stages that are also accurate enough to make reliable design decisions at these stages.

Much work has been done in academia to address this problem. E. Macii et al. present an overview of the different power estimation methods in VLSI circuits at different levels of abstraction [NPL1]. Two main approaches exist at the higher level of abstraction: Look-up Table (LUT) based and linear regression methods. Both are used to pre-characterize the power profile of basic blocks in order to estimate the power consumption at higher abstraction levels. An example of the LUT approach is described in detail in [NPL2]. On the other hand, S. Ravi et al. present a linear regression method, where regression-based power libraries for basic hardware components are built [NPL3]. In order to improve accuracy of the linear regression methods, building of regression trees is proposed in [NPL4]. In this case, the power profile is portioned according to some criteria to make the linear regression more accurate and linear regression is executed only for the data subset. Most of these approaches, i.e., the regression-based approaches, are only suitable for average power estimation, and are not used for determining instant cycle power consumption by cycle estimation approaches. Wu et al. also show that linear regression alone does not yield the desired accuracy results and propose a similar piece-wise linear regression model [NPL5].

The regression-based macro-model power estimation methods build a power library for basic hardware blocks by creating a power profile for each of them and performing a linear regression on this power profile. The regression coefficients are then stored in the power library, allowing much more compact power characterization libraries, than the LUT-based methods.

The drawback of the regression-based power estimation methods is that they can not deal with non-linear power consumption behaviors of the basic hardware components. Non-linear behaviors happen when, for example., a ripple in a ripple carry adder occurs. In the worst case, the ripple is propagated through all the outputs thereby causing a power consumption burst.

On the other hand, the LUT-based approaches can deal with non-linear behaviors by storing the different power values of each component in the LUTs, although this leads to much larger library sizes than regression-based methods.

In addition, various patent documents in the field of EDA relate to the power estimation as follows: JP-A-222561 [PL1] discloses a logic designing apparatus for VLSI design which includes a emulation circuit and estimates power consumption of the target VLSI by actually measuring current and voltage values at the emulation circuit. U.S. Pat. No. 6,735,744 [PL2] issued to Raghunathan et al. discloses a method of creating models for power estimation of a circuit comprising generating an input space for the circuit. In this method, the input space is separated into multiple power modes corresponding to regions that display similar power behavior, and separate power models are generated for each of the multiple power modes. A power mode identification function is created that selects an appropriate power model from the separate power models based on the present and past values of the circuit inputs. US-2005/0192887A1 [PL3] discloses a simulation apparatus which is capable of measuring power consumption in a higher abstract degree than an RT level. In the simulation apparatus, while a cycle base model of a target circuit is arranged by a state control module model, a calculation module model, and a memory model, the estimation of power consumption is realized by adding information such as an area and a wiring capacitance to an activating ratio measurement of a simulation model.

In summary, each of the regression-based method and the LUT-based method is a major approach to estimate power consumption of a target semiconductor device, e.g., a VLSI or IC, at the time of designing the semiconductor device. Each of these approaches has its advantages and disadvantages, as described above. Therefore, there is demand for the accurate modeling of instant (i.e., cycle accurate) and average power estimation at early design stages, i.e., behavioral level and register transfer level.

### SUMMARY OF THE INVENTION

An exemplary object of the present invention is to provide a power estimation method and apparatus which can precisely estimate both instant and average power consumption of a target device upon designing the target device.

Another exemplary object of the present invention is to provide a method and apparatus of creating a hybrid power library which is used for precisely estimating both instant and average power consumption of a target device upon designing the target device.

According to one exemplary aspect of the present invention, a method of estimating power consumption of a target device upon designing the target device comprises: preparing a hybrid power library having a regression power library part and lookup-table power library part, the hybrid power library storing power characteristics for each of basic building blocks which will constitute the target device; and estimating power consumption of the target device by applying the hybrid power library to a design description of the target device.

According to another exemplary aspect of the present invention, a method of creating a power library which is used for estimating power consumption of a target device upon designing the target device comprises: generating an initial set of the regression power library part and the look-up table power library part, the regression power library part storing power characteristics for each of basic building blocks and being used in regression-based power estimation of the target device, the look-up table power library storing power characteristics for each of the basic building blocks and being used in look-up table-based power estimation of the target device; estimating power consumption of at least one basic building block for a set of input data; performing regression on power values obtained by of the power estimation for the basic building block to generate the regression power library part; detecting an outlier in the power values; deleting the outlier from the regression power library part to move the deleted outlier to the look-up table power library part; re-generating the regression power library part by performing the regression without the detected outlier; and repeating the detecting, deleting and re-generating until a user's specified constraint is met.

According to yet another exemplary aspect of the present invention, an apparatus of estimating power consumption of a target device upon designing the target device comprises: a first storage storing a regression power library part which stores power characteristics for each of basic building blocks and is used in regression-based power estimation of the target device; a second storage storing a lookup-table power library part which stores power characteristics for each of the basic building blocks and is used in look-up table-based power estimation of the target device; an input device receiving a design description of the target device; a logic synthesizer performing logic synthesis using the design description and estimating power consumption of a circuit obtained by the logic synthesis by using the regression power library part and the lookup-table power library part; and an output device delivering results of the power estimation.

According to still another exemplary aspect of the present invention, an apparatus of creating a power library which is used for estimating power consumption of a target device upon designing the target device comprises: a first storage storing a regression power library part which stores power characteristics for each of basic building blocks and is used in regression-based power estimation of the target device; a second storage storing a lookup-table power library part which stores power characteristics for each of the basic building blocks and is used in look-up table-based power estimation of the target device; a power simulator estimating power consumption of at least one basic building block for a set of input data; a regression unit performing regression on power values obtained by of the power simulator to store the power values in the regression power library part stored in the first storage, an outlier detector detecting an outlier in the power values and deleting the outlier from the regression power library part stored in the first storage to move the deleted outlier to the look-up table power library part stored in the second storage, wherein the regression power library part is re-generated by performing the regression without the detected outlier, and the detection, deletion and moving of the outlier and the re-generation of the regression power library part are repeated until a user's specified constraint is met.

According to the exemplary aspects for the power consumption estimation, a hybrid approach based on a combination of linear regression approach and LUT-based approach is provided for power estimation. The power library which is used in the power estimation includes a linear regression power library part and an LUT-based power library part. The power library for a given set of basic hardware blocks can be generated at a given minimum precision defined by a user. According to the hybrid approach, it is possible to accurately estimate instant or cycle power consumption of a target device and tune the library precision to any desired precision.

According to the exemplary aspects for the generation of the power library, the outliers are removed from the regression power library part and moved to the LUT (lock-up table) power library part. Therefore, accuracy of the power estimation using the thus created power library is improved.

The above and other objects, features, and advantages of the present invention will become apparent from the following description based on the accompanying drawings which illustrate exemplary embodiments of the present invention.

### BRIEF DESCRIPTION OF THE DRAWINGS

FIG. 1 is a graph illustrating an overview of various power estimation methods at different VLSI design stages vs. power savings potential;

FIG. 2 is a diagram illustrating entire power estimation process according to an exemplary embodiment of the invention, showing an overview of power library generation flow and power estimation flow;

FIG. 3 is a diagram illustrating generation of tunable dual power libraries according to an exemplary embodiment of the invention;

FIG. 4 is a graph illustrating impact of non-linearties (considered as outliers) on the power estimation accuracy in the regression-based power estimation method;

FIG. 5 is a graph illustrating determination of outliers based on a boundary condition set by a user;

FIG. 6 is a graph illustrating deletion of outliers from the linear regression model and storing the deleted outliers in an LUT-based power estimation library;

FIG. 7 is a block diagram illustrating a power estimation apparatus;

FIG. 8 is a block diagram showing an information processing apparatus;

FIG. 9 is a graph illustrating the result of simulation of the gate netlist power estimation of a 4-bit adder by a commercial tool compared to the linear regression when outliers outside the range of 200% the estimated power value are moved to the external LUT-based power library;

FIG. 10 is a graph illustrating the result of simulation of the gate netlist power estimation of a 4-bit adder by a commercial tool compared to the linear regression when outliers outside the range of 100% the estimated power value are moved to the external LUT-based power library;

FIG. 11 is a graph illustrating the result of simulation of the gate netlist power estimation of a 4-bit adder by a commercial tool compared to the linear regression when outliers outside the range of 50% the estimated power value are moved to the external LUT-based power library;

FIG. 12 is a graph illustrating the result of simulation of the gate netlist power estimation of a 4-bit adder by a commercial tool compared to the linear regression when outliers outside the range of 25% the estimated power value are moved to the external LUT-based power library; and

FIG. 13 is a graph illustrating the result of simulation of the gate netlist power estimation of a 4-bit adder of a commercial tool compared to the linear regression when outliers outside the range of 10% the estimated power value are moved to the external LUT-based power library.

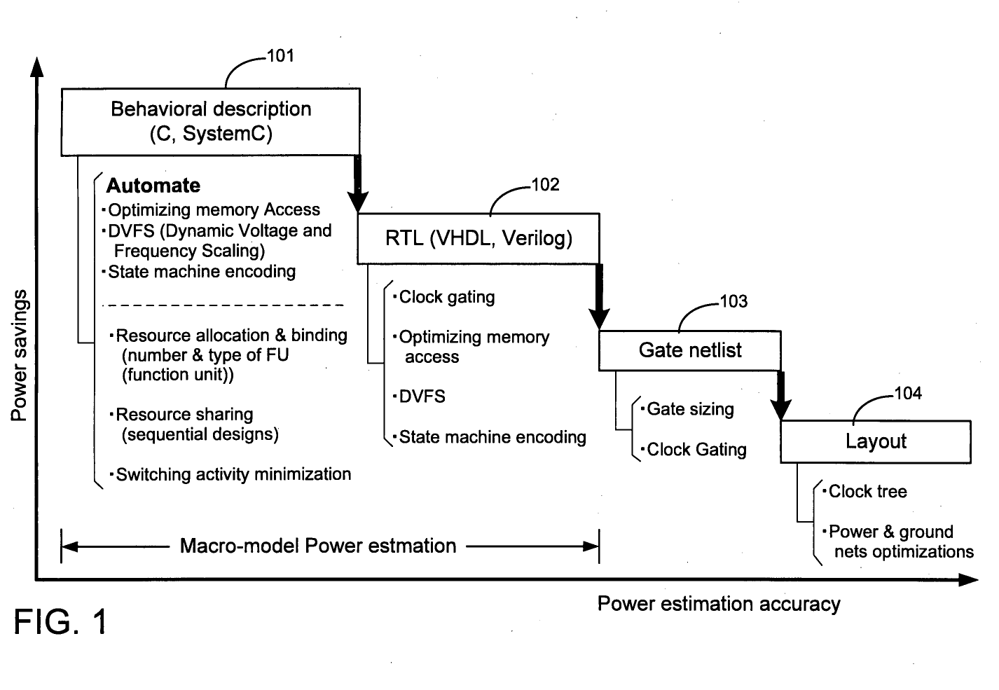

### DESCRIPTION OF EXEMPLARY EMBODIMENTS

Turning now descriptively to the drawings, in which similar reference characters denote similar elements throughout the several views, the attached figures illustrate exemplary embodiments of the present invention.

Briefly described, in one exemplary embodiment of the present invention, a power estimation of a target device upon designing the target device is based on pre-characterizing the power consumption of basic hardware components (e.g., adders, multipliers, multiplexers, and so on) in a library in order to estimate the total power consumption of the target design (i.e., the target device) by adding up the power consumed by each basic block constituting the target device. This approach is based on a combination of the well known linear regression method and the LUT-based method and uses a “hybrid” power library including: a linear regression power library part with the regression coefficients for each basic unit; and an LUT-based power library part storing individual power values of behaviors of each basic hardware component that cannot be modeled accurately by the linear regression model. Therefore, the exemplary embodiment provides the method of generating the “hybrid” power library.

The accuracy of the power estimation can be tuned by choosing the minimum tolerable estimation error. Choosing a perfect estimation (i.e., no error) means storing all power values corresponding on all inputs combinations of each basic unit in the LUT power library part of the power library, while providing a very loose constraint stores only the initial regression coefficients leaving the LUT-based library part empty. In the power estimation process, at least one of the input values, output values and transitions of each component block is used to retrieve the power values either from the regression-based library or the LUT-based

In the present exemplary embodiment, the power estimation libraries for a given set of basic hardware blocks are generated given a user defined minimum precision. This generation of the libraries is based on a combined LUT (look-up table) and linear regression approach. This approach is also called tunable approach as any desired precision can be achieved. Full precision means the storage of all power values in the LUT power library, while the lowest precision only considers the results of the original linear regression with no power values stored in the LUT power library. The more precise the larger the LUT power library becomes, whereas the linear regression power library has always the same size, storing the regression coefficients.

The generation of the power library at the designated precision uses the results of the linear regression power estimation for the basic block as initial values. The initial values correspond to the lowest precision case, and iteration processes are applied to improve the precision. The results of the linear regression power estimation get refined iteratively by deleting any non-linear behavior, which is considered as outliers, storing the detected outliers into an LUT-based library and re-generating linear regression coefficients by performing linear regression-based estimation based on the new regression power library, until a set of constraints are met, i.e., until the desired precision is achieved. This iteration process also improves the quality of the linear regression. These constraints are: for example, the minimum allowable precision, maximum size of the LUT, maximum allowable RMSE (root-mean-square error), maximum allowable average power error, maximum allowable maximum error, and linear regression significance (r²), but not limited to these.

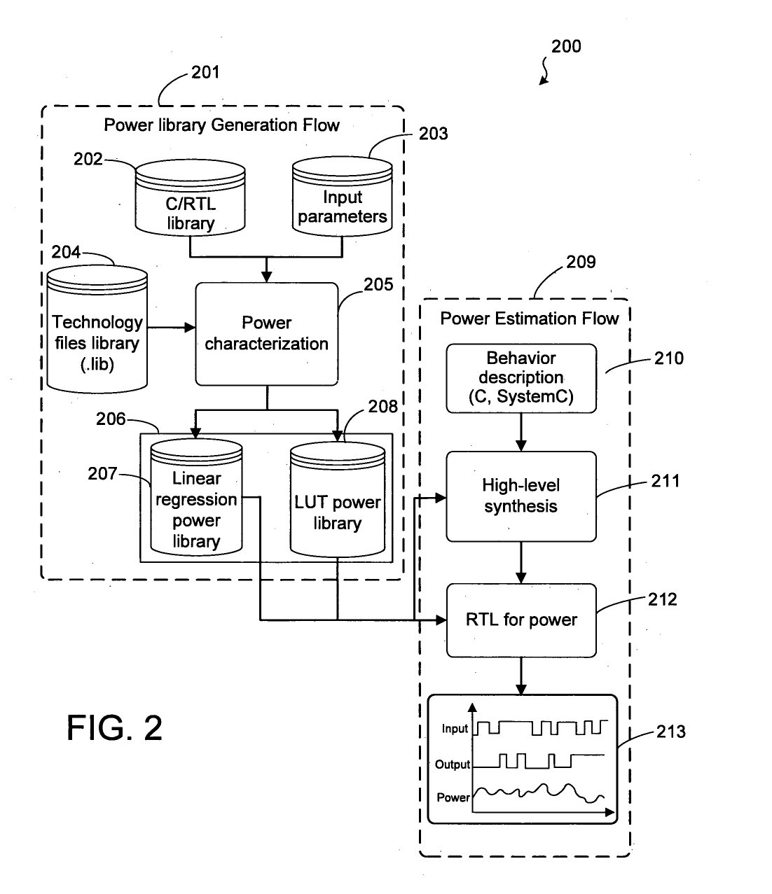

FIG. 2 illustrate flow 200 of the entire power estimation process for the target LSI or target VLSI. The entire process generally includes: power library generation process; and power simulation process using the generated power libraries. One flow 201 represents the creation of the power libraries 206 (i.e., linear regression power library 207 and LUT power library 208) based on C/RTL library 202, input parameters 203 and technology files library 204. Files in technology files library have filename extension of “.lib.” Another flow 209 represents the use of these libraries for the power estimation of any VLSI design. Power estimation flow 209 shows how and at which design stage these libraries are used.

The main process of power library generation flow 201 is power characterization 205. C/RTL library 202 stores design descriptions of any basic building blocks which are described in behavioral level (i.e., language C level) or RT level. As the power file of any basic building block stored in C/RTL library 202 is pre-characterized in the power libraries, the power at any design stage that can match its functional blocks to the pre-characterized unit stored in the power library can be applied. Each basic block in C/RTL library 202 is characterized based on a set of input parameters 203 and technology files library 204. Technology files library 204 stores technology files describing technologies for which these blocks will be characterized. The power consumption for each basic building block is characterized in power characterization process 205.

Through characterization process 205, power library 206 composed of linear regression part 207 and LUT part 208 is generated for all basic blocks in C/RTL library 202 for the given technology in technology library 204. Power library 206 is called a “hybrid power library” and can then be used to estimate the power consumption of any VLSI circuit at the high-level of abstraction. For example, if the design description 210 in, for example, a behavior level or RT level of a target VLSI is given, power library 206 will be used for the power estimation at high-level synthesis stage 211 of the target VLSI. In addition, power library 206 can be directly used for the power estimation at RTL stage 212. In both cases, accurate power consumption which has been estimated can then be displayed graphically in an RTL simulation or numerically in any readable format, as shown by reference numeral 213.

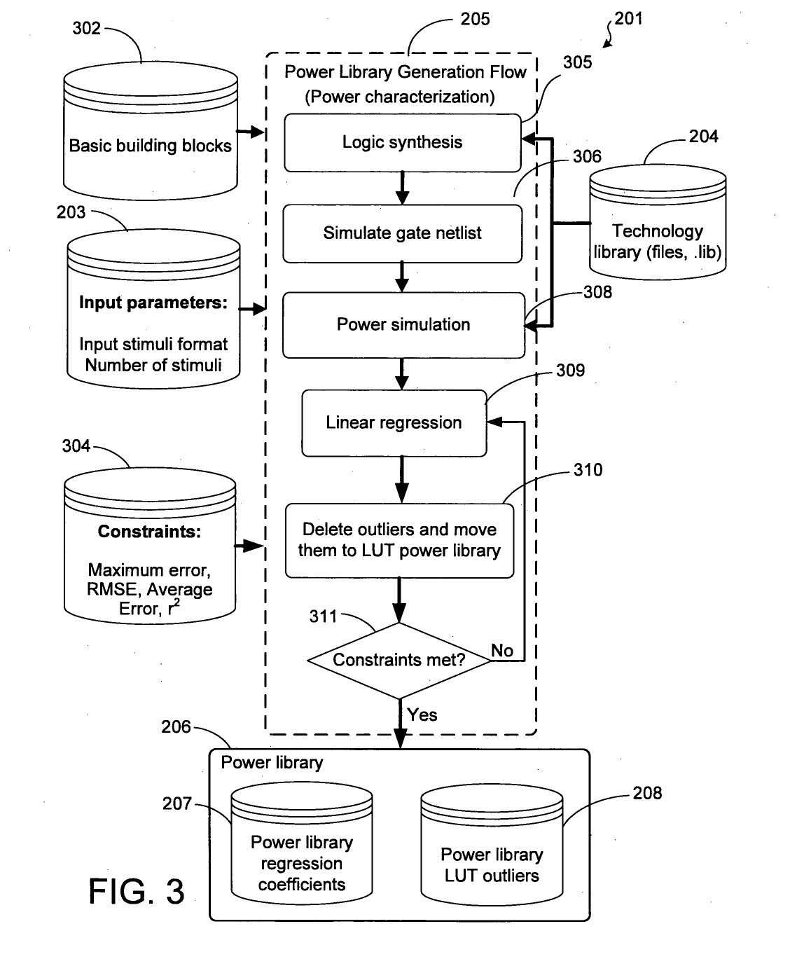

FIG. 3 illustrates in detail power library generation flow 201. In FIG. 3, basic building blocks 302 which are stored in C/RTL library shown in FIG. 2 are explicitly illustrated. These basic building blocks 302 includes blocks with different bit-widths and implementation types (e.g., carry ripple carry vs. carry save adder) that need to be pre-characterized. Basic building blocks are declared in any hardware description language such as C or RTL.

Power library generation flow 201, i.e., power characterization process 205, takes a number of inputs besides the basic building blocks. These inputs are: technology files stored in technology library 204; several input parameters 203, e.g., the size of the stimuli and the distribution; and several constraints 304. Constraints 304 are used for setting the minimum allowed power estimation precision, and include, for example, maximum error, RMSE (root-mean-square error), average error, or coefficient r² which is related to linear regression significance (r²). Depending on the desired accuracy of the power profile a power profile can be generated for each component at the RT-level, gate netlist level or placed gate netlist level.

In the flow, each basic block needs to be logically synthesized, in step 305, by using the technology file. Then the behavior of the logically-synthesized block is simulated, in step 306, using any gate netlist simulator, and a detailed power estimation tool in turn used, in step 308, to estimate the power consumption of each component based on simulation patterns given before. Based on the input patterns and the power profile, a linear regression is then performed in step 309 and an initial power library with the coefficients of the linear regression result is stored for all the basic building blocks.

Based on a set of constraints 304 specified by the user regarding the desired accuracy of the power estimation, the maximum allowable LUT size and/or the quality of the regression result, the flow iterates the linear regression of step 309 by moving the non-linearities of the power profile of each component to an LUT power library in step 310. In the iteration process, coefficient r² is the coefficient of determination of the linear regression and is used in statistical models to estimate the quality of the regression. Coefficient r² varies between 0 and 1. It is normally accepted in statistics that values of r² below 0.5 mean that there is no statistical significance between the predictors and the intercept, while an r² of 1 means a perfect match between the prediction and the regression curve. Once the non-linearities are removed in step 310 from the power profile for the linear regression, the linear regression is re-generated in step 309, and in turn it is checked if the constraints are met or not in step 311. The process iterates until the user constraints are met. In this case, a binary search method is used. However, any search algorithm can be used to meet the constraints minimizing the size of the LUT. The flow outputs the power library 206 composed of the linear regression power library 207 and the LUT power library 208.

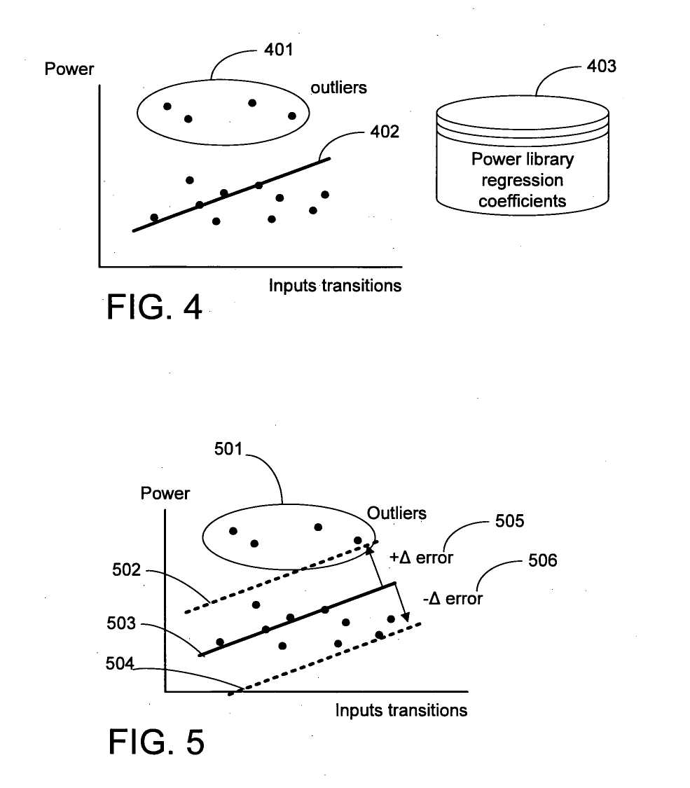

FIG. 4 illustrates the impact of non-linearities on the power estimation accuracy in the regression-based power estimation method. In this figure, the non-linearities are indicated by outliers 401 in a plot diagram. A pure regression-based power estimation method holds only the regression coefficients 403. Non-linearities have a strong impact on linear regression curve 402, biasing negatively the final result. The non-linearities are therefore treated as outliers 401. An example of non-linearity is when a ripple occurs at a ripple carry adder. If the ripple propagates from the first bit to the very last, leads to a power consumption burst, which the linear regression model cannot capture.

Now, the method for determining the outliers will be described. FIG. 5 illustrates the determination of boundary 501 of the outliers. The boundary is determined by taking linear regression line 503 as the reference. Upper frontier 502 and lower frontier 504 are established given maximum tolerable error margin (+Δ error) 505 and minimum tolerable error margin (−Δ error) 506. Assuming that both error margins are equal to each other, both frontiers 502, 504 and linear regression line 503 are arranged in the graph in parallel to each other with a interval of the margin. All points above upper frontier 502 and below lower frontier 504 are considered the outliers and moved to the LUT power library.

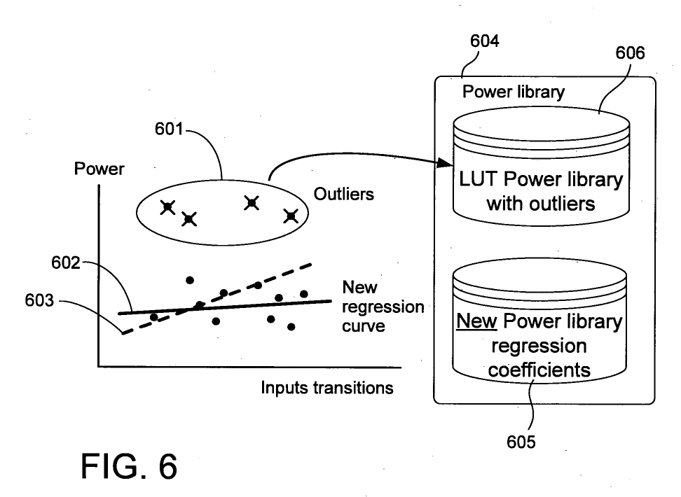

FIG. 6 illustrates the deletion of the outliers from the linear regression model and the impact of this deletion comparing the old regression curve and the new linear regression curve. In FIG. 6, outliers 601 have been determined using old regression curve 603. When outliers 601 are deleted from the linear regression model, the deleted outliers are then stored in LUT-based power estimation library 605. This deletion of outliers 601 have an influence on the regression curve and new regression curve 602 is generated. It can be observed that the linear regression line now more accurately models the remaining power values as the outliers have been deleted. Therefore, a new linear regression needs to be performed for the remaining simulation set and the regression coefficients are stored in new regression power library 605. New power library 604 is built with LUT power library 606 with outliers and new regression power library 605 with the new regression coefficients.

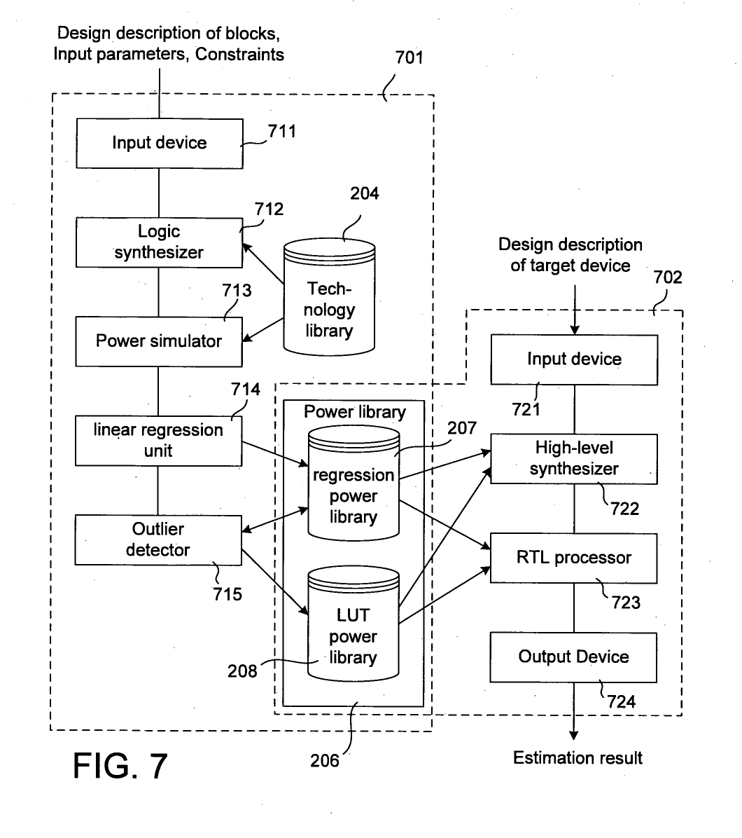

FIG. 7 illustrates configuration of a power estimation apparatus. The apparatus generally includes: library generation unit 701 which generates power library 206; and power estimation unit 702 which estimates power consumption of a target VLSI based on power library 206. In this apparatus, power library 206 has the same construction as described in FIG. 2 and includes regression power library 207 and LUT power library 208 both are configured as storage units.

Library generation unit 701 includes: input device 711 receiving design description of the basic building blocks, the input parameters and the constraints; technology library 204 including the technology files; logic synthesizer 712 performing logic synthesis of the received design description using the technology files and simulating the behavior of the logically-synthesized blocks using any gate netlist simulator; power simulator 713 estimating the power consumption of each basic building block for a set of input patterns; linear regression unit 714 performing linear regression on power values obtained by of power simulator 713 to store the power values in regression power library 207; and outlier detector 715 detecting an outlier in the power values and deleting the outlier from regression power library 207 to move the deleted outlier to LUT power library 208. In library generation unit 701, regression power library 207 is re-generated by performing the regression without the detected outlier, and the detection, deletion and moving of the outlier and the re-generation of regression power library 207 are repeated until the constraints are met.

On the other hand, power estimation unit 702 includes: input device 721 receiving a design description of the target device; high-level synthesizer 722 performing high-level synthesis of the design description and estimating power consumption using power library 206; RTL processor 723 performing logic synthesis at the RT level and estimating power consumption using power library 206; and output device 724 delivering the results of logic synthesis and power estimation. In this apparatus, power estimation of the target device is carried out at least one of high-level synthesizer 722 and RTL processor 723. In addition, when the RTL description of the target device is available, the high-level synthesizer is not necessary. In such a case, the power estimation is carried out only at RTL processor 723.

Each step constituting the method of the above exemplary embodiments may be also implementable on computer systems. Therefore, the exemplary embodiments may be implemented in a software manner as a computer program for use with a computer system. The program defining the functions of at least one exemplary embodiment can be provided to a computer via a variety of computer-readable media (i.e., signal-bearing medium), which include but are not limited to, (i) information permanently stored on non-writable storage media (e.g., read-only memory devices within a computer such as CD-ROM disks readable by a CD-ROM or DVD drive; (ii) alterable information stored on a writable storage media (e.g., flexible disks within flexible disk drive or hard-disk drive); or (iii) information conveyed to a computer by communications medium, such as through a computer or telephone network, including wireless communication. The latter specifically includes information conveyed via the Internet. Such signal-bearing media, when carrying computer-readable instructions that direct the functions defined by the inventive method, represent alternative exemplary embodiments of the invention. It may also be noted that portions of the program maybe developed and implemented independently, but when combined together constitute further exemplary embodiments of the invention.

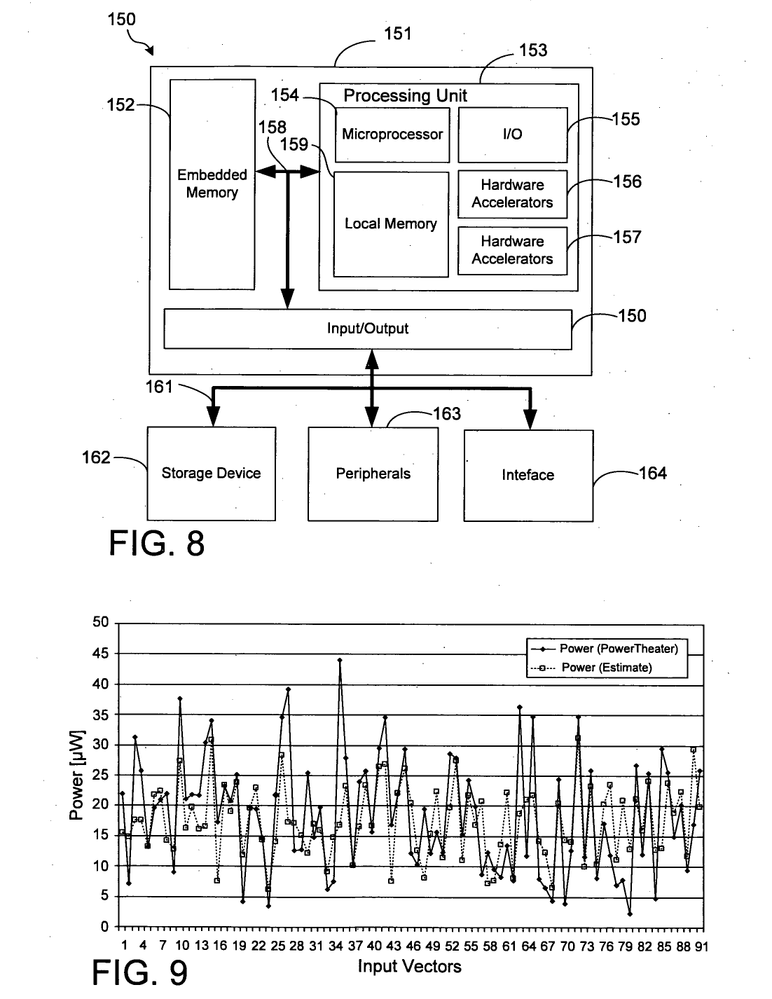

FIG. 8 shows a functional block diagram of an information processing apparatus. Information processing apparatus 150 includes complex processing device 151, which is a subsystem integrated on the same LSI design, including processing unit 153, embedded memory 152, input and output (I/O) port 160. I/O port 160 includes a communication interface. All units in complex processing device 151 are interconnected by inner bus 158. Processing apparatus 150 also includes: storage device 162, and different type of peripherals 163 and interfaces 164. Processing device 151, storage device 162, peripherals 163 and interfaces 164 are interconnected together by bus 161.

Processing unit 153 includes: microprocessor 154, embedded local memory 159, input and output (I/O) port 155 and two dedicated hardware acceleration blocks 156, 157. The acceleration blocks can perform a variety of functions more efficiently than a generic processor, i.e., microprocessor 154. The power consumed by each of the units and sub-units in processing unit 153 needs to be estimated as early as possible in the design stage of the target VLSI in order to implement the most effective power saving measures.

### EXAMPLES

The exemplary embodiments will now be described in greater detail in the context of examples. Here, the problem definition consists of two goals: (1) meeting a set of precision constraints for the power estimation, and (2) reducing the size of the LUT power library part.

TABLE 1 shows the results of the different number of iterations when applying the proposed method to a 4-bit ripple carry adder; At each iteration, the outlier boundary limit is narrowed from the previous iteration in order to improve the power estimation precision by moving more outliers from the regression power library to the LUT power library.

First Iteration: Initially, the outlier criterion is set to 200% of the value on the linear regression line. This means that power values above or below two times that estimated power value at the regression line are deleted and moved to the LUT. Applying this constraint finds that 0.3% of the inputs and toggling combinations to be outliers. The RMSE is 40% and the maximum error 184% (the limit is set to 200%). The average error when summing all the power values divided by all the sum of all estimated power values is 3.19%. Parameter r² indicates the significance of the linear regression on the power estimation. Normally, it is accepted that values of r² above 0.5 means statistical significance. In this case, r² is 0.31, below 0.5, indicating that the linear regression model can not model the power consumption of the adder with enough accuracy. FIG. 9 shows the result of a gate netlist power estimation simulation compared to the linear regression simulation without the outliers deleted at this iteration. The gate netlist power estimation simulation was carried out by using ‘PowerTheater’ software, available from Apache Design Solutions, Inc., San Jose, Calif., USA.

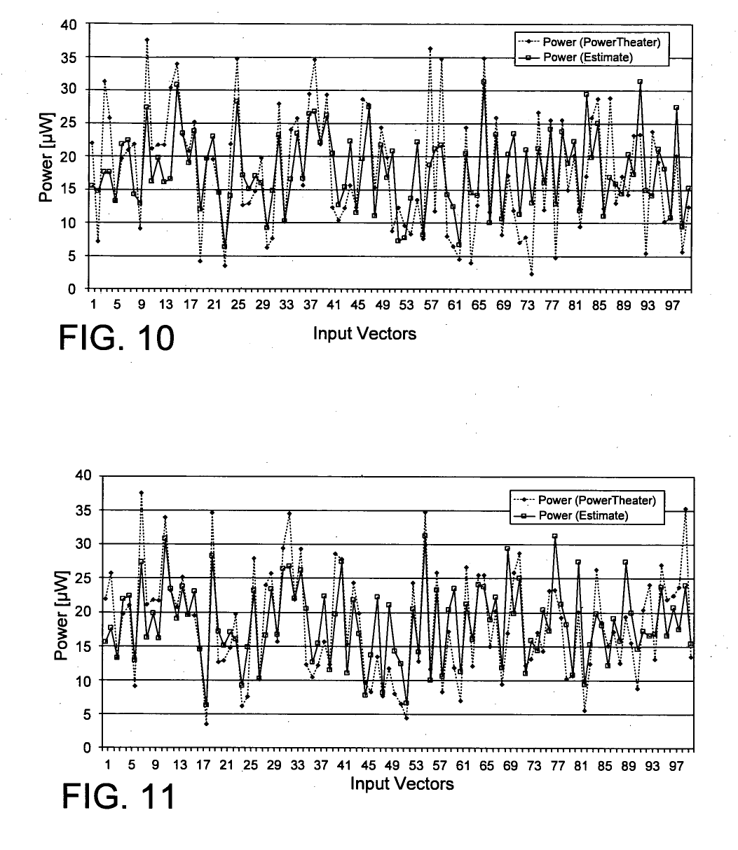

Second Iteration: At the next iteration, the outlier boundary is further narrowed to 100% of the estimated power value from the regression curve. In this case, the number of outliers found increases to 0.35% of all the power values, while the power estimation errors are reduced to 38.7% RMSE, 84% of maximum error and 1.74% of average error. The statistical significance of the regression result slightly increases from 0.31 to 0.37, but is still below the threshold of 0.5 to hold statistical significance. FIG. 10 shows the result of the gate netlist power estimation simulation compared to the linear regression without the outliers deleted at this iteration.

Third Iteration: At this iteration, the outlier boundary is further narrowed to consider the outliers all power values above 50% of the estimate power value on the regression curve. At this stage, parameter r² shows statistical significance, surpassing the 0.5 threshold and the RMSE and maximum error get reduced to 28.56% and 49.24%, respectively. The drawback is that 25% of the input combinations need to be stored in the separated LUT power library. FIG. 11 shows the result of the gate netlist power estimation simulation compared to the linear regression without the outliers deleted at this iteration.

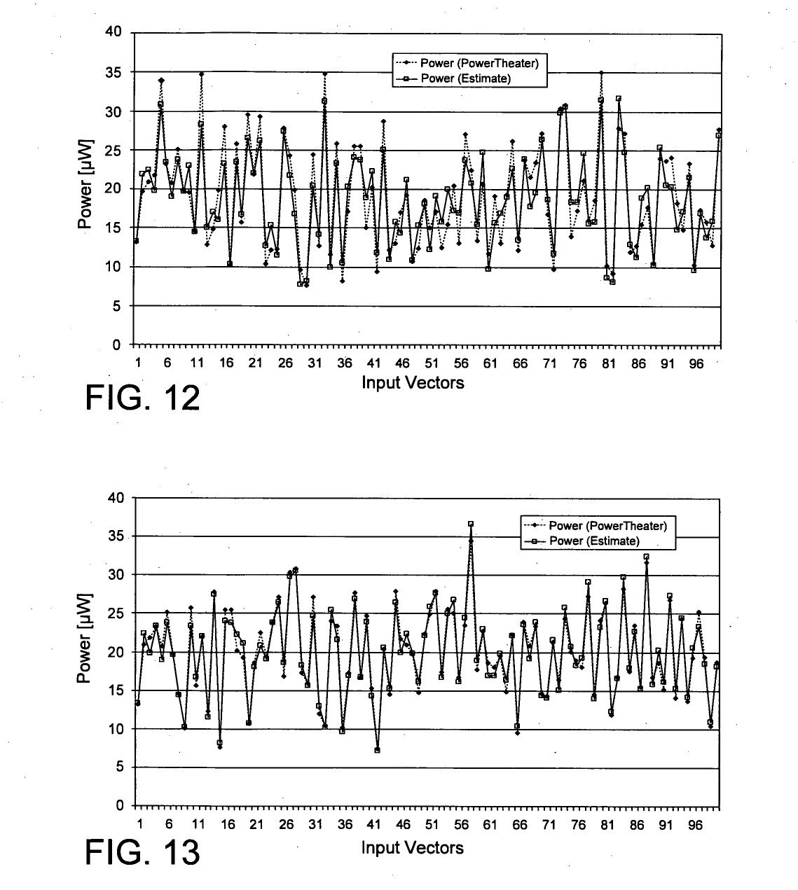

Fourth Iteration: The outlier boundary is set to 25% at this iteration. 58.13% of the values are now stored at the LUT power library, while the RMSE and max error are reduced to 14.87% and 24.72%, respectively. The average error only reaches 0.76% and r² of 0.82 show a very high statistical significance of the regression. FIG. 12 shows the result of the gate netlist power estimation simulation compared to the linear regression without the outliers deleted at this iteration.

Fifth Iteration: At the last iteration, the outlier boundary is set to a very narrow range of acceptable values only within ±10% of the estimated power value. In this case, 83.1% of the cases need to be stored in the LUT, and the RMSE and maximum error get significantly reduced to 5.94% and 9.76%, respectively, while the average error is 0.04%. The statistical significance of the linear regression is almost 1. FIG. 13 shows the result of the gate netlist power estimation simulation compared to the linear regression showing almost complete overlap in the graph.

TABLE 1
5-iterations example for a 4-bit ripple carry adder

| Iteration | 1st step | 2nd step | 3rd step | 4th step | 5th step |
|---|---|---|---|---|---|
| Outlier maximum | 200% | 100% | 50% | 25% | 10% |
| Number of outliers | 0.3% | 0.35% | 25% | 58.13% | 83.1% |
| RMSE (%) | 40% | 38.7% | 28.56% | 14.87% | 5.94% |
| Error Maximum (%) | 184% | 84% | 49.24% | 24.72% | 9.76% |
| Error Average (%) | 3.19% | 1.74% | 1.5% | 0.76% | 0.04% |
| Coefficient r² | 0.31 | 0.37 | 0.55 | 0.82 | 0.97 |

The results shown in this example only represent the power characterization of a 4-bit ripple carry adder. Each building block (e.g., multipliers, multiplexers, decoders) has its own power profile that leads to different results.

Although the exemplary embodiments and examples are presented in the context of circuit design example, the method and apparatus according to the present invention is applicable to many other types of design problems including, for example, design problems relating to digital circuits, scheduling, chemical processing, control systems, neuronal networks, verification and validation methods, regression modeling, identification of unknown systems, communications networks, optical circuits, sensors and flow network design problems such as road systems, waterways and other large scale physical networks, optics, mechanical components and optoelectrical components.

It will be apparent that other variations and modifications may be made to the above described exemplary embodiments, examples and functionality, with the attainment of some or all of their advantages. It is an object of the appended claims to cover all such variations and modifications as come within the true spirit and scope of the invention.

The whole or part of the exemplary embodiments disclosed above can be described as, but not limited to, the following supplementary notes:

(Supplementary Note 1) A method for creating precision tunable pre-characterization power libraries, comprising:

creating hybrid power library including a linear regression power library part and an LUT (look-up table) based power library part to increase total power estimation accuracy; and

re-generating the hybrid power library with desired precision which corresponds to specified desired precision level.

(Supplementary Note 2) The method according to Supplementary Note 1, further comprising:

considering non-linearity in power behavior of a modeled hardware block as a regression outlier; and

moving the outlier from the linear regression power library part to the LUT based power library part.

(Supplementary Note 3) The method according to Supplementary Note 2, all the non-linearities in the power behavior are moved from the linear regression power library part to the LUT based power library part.

(Supplementary Note 4) The method according to Supplementary Note 1, wherein the re-generating includes re-generating the linear regression power library part based on a new set of power values without the outliers.

(Supplementary Note 5) The method according to Supplementary Note 3, further including re-building a power estimation method based on a re-generated new regression based power library and the LUT power library part containing all outliers.

(Supplementary Note 6) The method according to Supplementary Note 2, wherein, in the moving, an iterative method is considered to remove the minimum number of the outliers to meet the precision constraints.

(Supplementary Note 7) An apparatus for automatically generating the power library, comprising:

a generator generating a power profile of each basic block at least one precision level (e.g., RTL power profile, gate netlist or placed netlist), the generator pre-characterizing the power profile in a linear regression power library part and LUT-based power library part.

(Supplementary Note 8) The apparatus according to Supplementary Note 7, further comprising: an automatic interface generator to use the library parts to a simulator at least one design stage.

(Supplementary Note 9) An apparatus for automatically generating the power library, comprising:

an input device for receiving inputs to build a power library;

a generator generating an initial regression-based power library;

a detector detecting an outlier in the regression-based power library to extract the outlier from the regression-based power library.

(Supplementary Note 10) The apparatus according to Supplementary Note 9, further comprising an output device delivering the power library results.

(Supplementary Note 11) A method for estimating power consumption of a target device upon designing the target device, comprising:

preparing a hybrid power library having a regression power library part and lookup-table library part, the hybrid power library storing power characteristics for each of basic building blocks which will constitute the target device; and

estimating power consumption of the target device by applying the hybrid power library to a design description of the target device.

(Supplementary Note 12) The method according to Supplementary Note 11, wherein the regression power library part stores regression coefficients for each basic building block; and the look-up table power library part stores individual power values of behaviors of each basic building block that cannot be modeled accurately by a regression model.

(Supplementary Note 13) The method according to Supplementary Note 12, wherein the preparing the hybrid power library includes:

estimating power consumption of at least one basic building block for a set of input data;

performing regression on power values obtained by of the power estimation for the basic building block to generate the regression power library part;

detecting an outlier in the power values;

deleting the outlier from the regression power library part to move the deleted outlier to the look-up table power library part;

re-generating the regression power library part by performing the regression without the detected outlier; and

repeating the detecting, deleting and re-generating until a user's specified constraint is met.

(Supplementary Note 14) A method of creating a power library which is used for estimating power consumption of a target device upon designing the target device, the method comprising:

generating an initial set of the regression power library part and the look-up table power library part, the regression power library part storing power characteristics for each of basic building blocks and being used in regression-based power estimation of the target device, the look-up table power library storing power characteristics for each of the basic building blocks and being used in look-up table-based power estimation of the target device;

estimating power consumption of at least one basic building block for a set of input data;

performing regression on power values obtained by of the power estimation for the basic building block to generate the regression power library part;

detecting an outlier in the power values;

deleting the outlier from the regression power library part to move the deleted outlier to the look-up table power library part;

re-generating the regression power library part by performing the regression without the detected outlier; and

repeating the detecting, deleting and re-generating until a user's specified constraint is met.

(Supplementary Note 15) The method according to Supplementary Note 14, wherein a power value located outside a range from a regression line is determined as the outlier.

(Supplementary Note 16) The method according to Supplementary Note 14, wherein the regression-based power estimation is linear regression-based power estimation.

(Supplementary Note 17) An apparatus of estimating power consumption of a target device upon designing the target device, comprising:

a first storage storing a regression power library part which stores power characteristics for each of basic building blocks and is used in regression-based power estimation of the target device;

a second storage storing a lookup-table power library part which stores power characteristics for each of the basic building blocks and is used in look-up table-based power estimation of the target device;

an input device receiving a design description of the target device;

a logic synthesizer performing logic synthesis using the design description and estimating power consumption of a circuit obtained by the logic synthesis by using the regression power library part and the lookup-table power library part; and

an output device delivering results of the power estimation. (

Supplementary Note 18) The apparatus according to Supplementary Note 17, further comprising:

a power library generator which estimates power consumption of at least one basic building block for a set of input data, performs regression on power values obtained by of the power estimation for the basic building block to generate the regression power library part, detects an outlier in the power values, deletes the outlier from the regression power library part to move the deleted outlier to the look-up table power library part, re-generates the regression power library part by performing the regression without the detected outlier, and repeats the detection, deletion and moving of the outlier and the re-generation of the regression power library part.

(Supplementary Note 19) An apparatus of creating a power library which is used for estimating power consumption of a target device upon designing the target device, comprising:

a first storage storing a regression power library part which stores power characteristics for each of basic building blocks and is used in regression-based power estimation of the target device;

a second storage storing a lookup-table power library part which stores power characteristics for each of the basic building blocks and is used in look-up table-based power estimation of the target device;

a power simulator estimating power consumption of at least one basic building block for a set of input data;

a regression unit performing regression on power values obtained by of the power simulator to store the power values in the regression power library part stored in the first storage,

an outlier detector detecting an outlier in the power values and deleting the outlier from the regression power library part stored in the first storage to move the deleted outlier to the look-up table power library part stored in the second storage,

wherein the regression power library part is re-generated by performing the regression without the detected outlier, and the detection, deletion and moving of the outlier and the re-generation of the regression power library part are repeated until a user's specified constraint is met.

(Supplementary Note 20) The apparatus according to Supplementary Note 19, further comprising:

an input apparatus receiving a design description of each of the basic building blocks; and

a logic synthesizer performing logic synthesis of the design description to generate a netlist of the basic building block.

### CITATION LIST:

Patent Literatures:

[PL1] JP-A-2001-222561.

[PL2] U.S. Pat. No. 6,735,744

[PL3] US-2005-0192787-A1

Non-Patent Literatures:

[NPL1] E. Macii, M. Pedram, and F. Somenzi, “High-Level Power Modeling, Estimation, and Optimization,” Proceeding of the 34th annual Design Automation Conference (DAC '97), pp. 504-511, Anaheim, Calif., 1997.

[NPL2] S. Gupta, and F. N. Najim, “Power Macromodeling for High Level Power Estimation,” 34th Conference on Design Automation Conference (DAC '97), pp. 365-370, Anaheim, Calif., 1997.

[NPL3] S. Ravi, A. Raghunathan, and S. Chakradhar, “Efficient RTL Power Estimation for Large Designs,” Proceedings of 16th International Conference on VLSI Design (VLSI '03), 2003.

[NPL4] A. Bogliolo, L. Benini, and G. de Micheli, “Regression-Based RTL Power Modeling,” ACM Transactions on Design Automation of Electronics Systems, Vol. 5, No. 3, pp. 337-372, July 2000.

[NPL5] Q. Wu, Q. Qiu, M. Pedram, and C. Ding, “Cycle-Accurate Macro-Models for RT-Level Power Analysis,” IEEE Transaction on Very Large Scale Integration (VLSI) Systems, Vol. 4, No. 4, pp. 520-528, December 1998.

1. A method of estimating power consumption of a target device upon designing the target device, comprising:
preparing a hybrid power library having a regression power library part and lookup-table power library part, the hybrid power library storing power characteristics for each of basic building blocks which will constitute the target device; and
estimating power consumption of the target device by applying the hybrid power library to a design description of the target device.

2. The method according to claim 1, wherein the regression power library part stores regression coefficients for each basic building block; and the look-up table power library part stores individual power values of behaviors of each basic building block that are not modeled accurately by a regression model.

3. The method according to claim 2, wherein the preparing the hybrid power library includes:
estimating power consumption of at least one basic building block for a set of input data;
performing regression on power values obtained by of the power estimation for the basic building block to generate the regression power library part;
detecting an outlier in the power values;
deleting the outlier from the regression power library part to move the deleted outlier to the look-up table power library part;
re-generating the regression power library part by performing the regression without the detected outlier; and
repeating the detecting, deleting and re-generating until a user's specified constraint is met.

4. A method of creating a power library which is used for estimating power consumption of a target device upon designing the target device, the method comprising:
generating an initial set of the regression power library part and the look-up table power library part, the regression power library part storing power characteristics for each of basic building blocks and being used in regression-based power estimation of the target device, the look-up table power library storing power characteristics for each of the basic building blocks and being used in look-up table-based power estimation of the target device;
estimating power consumption of at least one basic building block for a set of input data;
performing regression on power values obtained by of the power estimation for the basic building block to generate the regression power library part;
detecting an outlier in the power values;
deleting the outlier from the regression power library part to move the deleted outlier to the look-up table power library part;
re-generating the regression power library part by performing the regression without the detected outlier; and
repeating the detecting, deleting and re-generating until a user's specified constraint is met.

5. The method according to claim 4, wherein a power value located outside a range from a regression line is determined as the outlier.

6. The method according to claim 4, wherein the regression is linear regression.

7. An apparatus of estimating power consumption of a target device upon designing the target device, comprising:
a first storage storing a regression power library part which stores power characteristics for each of basic building blocks and is used in regression-based power estimation of the target device;
a second storage storing a lookup-table power library part which stores power characteristics for each of the basic building blocks and is used in look-up table-based power estimation of the target device;
an input device receiving a design description of the target device;
a logic synthesizer performing logic synthesis using the design description and estimating power consumption of a circuit obtained by logic synthesis by using the regression power library part and the lookup-table power library part; and
an output device delivering results of the power estimation.

8. The apparatus according to claim 7, further comprising:
a power library generator which estimates power consumption of at least one basic building block for a set of input data, performs regression on power values obtained by of the power estimation for the basic building block to generate the regression power library part, detects an outlier in the power values, deletes the outlier from the regression power library part to move the deleted outlier to the look-up table power library part, re-generates the regression power library part by performing the regression without the detected outlier, and repeats the detection, deletion and moving of the outlier and the re-generation of the regression power library part.

9. An apparatus of creating a power library which is used for estimating power consumption of a target device upon designing the target device, comprising:
a first storage storing a regression power library part which stores power characteristics for each of basic building blocks and is used in regression-based power estimation of the target device;
a second storage storing a lookup-table power library part which stores power characteristics for each of the basic building blocks and is used in look-up table-based power estimation of the target device;
a power simulator estimating power consumption of at least one basic building block for a set of input data;
a regression unit performing regression on power values obtained by of the power simulator to store the power values in the regression power library part stored in the first storage,
an outlier detector detecting an outlier in the power values and deleting the outlier from the regression power library part stored in the first storage to move the deleted outlier to the look-up table power library part stored in the second storage,
wherein the regression power library part is re-generated by performing the regression without the detected outlier, and the detection, deletion and moving of the outlier and the re-generation of the regression power library part are repeated until a user's specified constraint is met.

10. The apparatus according to claim 9, further comprising:
an input apparatus receiving a design description of each of the basic building blocks; and
a logic synthesizer performing logic synthesis of the design description to generate a netlist of the basic building block.
